(19) United States
(12) Patent Application Publication
(10) Pub. No.: US 2006/0288298 A1
(43) Pub. Date: Dec. 21, 2006

(54) System, method and technique for enabling users to interact with address fields of messaging applications

(76) Inventors: Robert Haitani, Menlo Park, CA (US); Richard J. Donald, Brentwood, CA (US); Sachin Kansal, Sunnyvale, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/434,504

(22) Filed: May 14, 2006

Related U.S. Application Data
(63) Continuation-in-part of application No. 11/231,631, filed on Sep. 20, 2005.
Application No. 11/231,631 is a continuation-in-part of application No. 09/977,871, filed on Oct. 14, 2001, now Pat. No. 7,007,239.
Application No. 09/977,871 is a continuation-in-part of application No. 09/668,123, filed on Sep. 21, 2000, now Pat. No. 6,781,575.
Application No. 09/977,871 is a continuation-in-part of application No. 09/374,095, filed on Aug. 12, 1999, now Pat. No. 6,516,202.

(51) Int. Cl. G06F 17/00

(52) U.S. Cl. 715/739

(57) ABSTRACT

An input is received for an address field of a message that is to be transmitted from a messaging application. A contact record is associated from the input with the message. A recipient address is selected from the identified contact record for use as an address field value. An input is detected from the user, and subsequently, the user is enabled to edit the address field value. In one embodiment, the user is enabled to edit the address field value by either allowing the user to select a new recipient address from the identified contact record, or by allowing the user to create an alternative recipient address that is not part of the contact record.

### TECHNICAL FIELD

This patent application is a continuation-in-part of, and claims a benefit and priority to, U.S. patent application Ser. No. 11/231,631, filed on Sep. 20, 2005, titled “Integrated Handheld Computing and Telephony System and services”; which is a continuation-in-part of U.S. patent application Ser. No. 09/977,871, filed Oct. 14, 2001, titled “Method and Apparatus for Accessing a Contacts Database and Telephone Services”, which is a continuation-in-part of and claims a benefit of U.S. patent application Ser. No. 09/668,123, filed Sep. 21, 2000, titled “Method and Apparatus for Organizing Addressing Elements”, now U.S. Pat. No. 6,781,575, and a continuation-in-part of and claims a benefit of U.S. patent application Ser. No. 09/374,095, filed Aug. 12, 1999, titled “Mobile Computer System Designed for Wireless Communication Expansion”, now U.S. Pat. No. 6,516,202, the relevant contents of each of these applications herein being incorporated by reference.

### TECHNICAL FIELD

The disclosed embodiments relate generally to the field of electronic communications. In particular, the disclosed embodiments relate to a system, method and technique for enabling users to interact with address fields of messaging applications.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony and messaging devices. Even stand-alone telephones that connect to traditional Public Switched Telephone Networks (PSTN) are including more software to enhance the telephone's functionality.

In enhancing telephony/messaging operations with computing resources and software, effort has been made to enhance and assist the user in using-such devices, particularly for messaging applications. These devices have smaller keyboards that may be harder to operate, and/or use in mobile or dynamic environments, where the user cannot readily retrieve a desired message address.

There are now many types of communication types, and multi-functional devices exist to accommodate the different communication types. Examples of communication types other than telephony include e-mail, instant message (including SMS protocol messages and Multimedia Message Service (MMS) protocol messages), and video conferencing. Many computing devices, particularly multi-functional cellular messaging phones, are enabled to support communications using multiple communication mediums.

### BRIEF DESCRIPTION OF THE DRAWINGS

FIG. 1 illustrates a system for enabling users to interact and use address fields in connection with operation of one or more messaging applications, according to an embodiment of the invention.

FIG. 2 illustrates a contact lookup system for use with messaging applications, under an embodiment of the invention.

FIG. 3A-FIG. 3B illustrate an implementation of the use of lookup component in connection with a messaging application, according to an embodiment of the invention.

FIG. 4 illustrates a method for maintaining an MRU list, under an embodiment of the invention.

FIG. 5A illustrates components for implementing a method such as described with FIG. 4, according to one or more embodiments.

FIG. 5B illustrates MRU lists for different messaging applications, under an embodiment of the invention.

FIG. 6 is a table that illustrates how a search string value can be used to identify address field values from both a contact record database and a MRU list, under an embodiment of the invention.

FIG. 7A illustrates a method in which the delimiter for an address of a message is inserted automatically, at least in part, once the address field value for the message is determined.

FIG. 7B illustrates an address field on which addresses can be inserted, using an embodiment such as shown by FIG. 7A.

FIG. 8A illustrates an embodiment in which an address field value is placed in a selected or partially selected state for purpose of displaying or enabling the user to view information associated with the address field value, under one or more embodiments of the invention.

FIG. 8B illustrates an implementation of FIG. 8A, under an embodiment of the invention.

FIG. 9A illustrates a method for truncating an address field value of a message, under an embodiment of the invention.

FIG. 9B and FIG. 9C provide an illustration of a truncation of an address field value, under an embodiment of the invention

FIG. 10A illustrates components for enabling the viewing of contact record information from an addressed field of a messaging application, under one or more embodiments of the invention.

FIG. 10B illustrates a method for enabling the viewing of contact record information in connection with a displayed address field value, under one or more embodiments of the invention.

FIG. 11A illustrates components for enabling the editing and altering of contact record information from an addressed field of a messaging application, under one or more embodiments of the invention.

FIG. 11B illustrates a method for enabling the editing and altering of contact record information from an addressed field of a messaging application, under one or more embodiments of the invention.

FIG. 12A-12E are illustrations of a user-interface or address window presented with a given messaging application, describing a sequence of events by which the user can select and edit and address field value, under one or more embodiments of the invention.

FIG. 13 illustrates a method where editing operations of an address field can be incorporated into the operational state of a device, under an embodiment of the invention.

FIG. 14 illustrates a hardware diagram of a mobile computing device configured according to an embodiment of the invention.

### DETAILED DESCRIPTION

Embodiments described herein facilitate the use and interaction of address fields and operations of messaging applications in different kinds of computer system. As will be described, one or more embodiments described herein facilitate the use of address fields in messaging programs of various kinds, for purposes that include: (i) enabling location and selection of a new recipient address for a given message; (ii) enable retrieval and viewing of information associated with message addresses; (iii) optimize the viewing of message addresses on small form-factor devices (e.g. mobile computing devices); and/or (iv) enable address field editing in a manner that requires minimal user-effort.

Embodiments described in this application may be implemented on any type of computer that is connected to a network or communication medium to enable transmission and/or reception of messages carried over networks. Once type of computer on which embodiments described herein may be implemented is a mobile computing device, such as a cellular computing device, wireless messaging device, personal digital assistant, or hybrid/multi-functional device for enabling cellular voice and data transmissions. These devices typically have relatively limited display sizes, processing resources, and display area. The ease of use and flexibility provided by embodiments described herein, in connection with addressing messages, has benefit to such devices, as functionality described in connection with such embodiments compensates for the relatively more limited resources such devices typically have. However, embodiments described herein may also be implemented by desktop computers, laptop computers, and large profile computers.

An embodiment described herein enables a user to operate a messaging application on a computing device. An input is received for an address field of a message that is to be transmitted from a messaging application. A contact record is associated from the input with the message. A recipient address is selected from the identified contact record for use as an address field value. An input is detected from the user, and subsequently, the user is enabled to edit the address field value. In one embodiment, the user is enabled to edit the address field value by either allowing the user to select a new recipient address from the identified contact record, or by allowing the user to create an alternative recipient address that is not part of the contact record.

According to another embodiment, an input is received from the user that specifies a recipient address for an address field value. An identifier of a contact record is displayed, the identifier of the contact record containing the recipient address of the address field value. In response to the user selecting to view the address field value, displaying information from the contact record that is in addition to the recipient address.

According to another embodiment, information is identified about a recipient of a message that is composed or transmitted from the computing device using the one or more messaging applications. A list entry may be formed, where, if an address field value of the message is associated with a contact record, the contact name or identifier is included in the list entry. Otherwise, the list entry may display a recipient address of that message. The list may be updated to reflect recipients that have been most recently messaged.

According to another embodiment, input is receiving for an address field of a message. The recipient address of the address field is established from the input for the message. The recipient address, or an alternative identifier associated with the recipient address, is then displayed in a view. According to one embodiment, the view is the address line on which the recipient address is provided. Alternatively, the view may be in the form of a window or other display. The usr can edit the recipient address from the view. One or more embodiments further provide for a view, panel, or interface (alternatively or collectively referred to as a “panel” containing an address field in which a user can select, compose or otherwise specify an address field value. Logic may be associated with the panel to enable the user to edit the address field value on the address line, even after the address field value is established atomically for messaging operations.

Numerous other embodiments and implementations are described through out this application.

As used herein, the term “address field” refers to a property of a message that is provided an address or other identifier of a recipient. An example of an address field is the “TO:” field in an email or text message.

As used herein, the term “address field value” means one or more values assigned to an address field of a messaging application. An address field value may have a display component and a recipient address. The display component of the address field value includes characters that are displayed to the user for the address field value at a given instance. The recipient address includes characters that identify the address, location and/or destination of the message that is to be transmitted. For example, in an email application, the address may correspond to the email address, while the display component may be a name of a contact record in which the email address may be found. In many cases, the address component of the address field value is selectively or intermittingly viewable to the user. The following is illustrative:

TO: “John”<John.Doe@palm.com>

In this example, the address field is “TO:”, the address field value is “Joh”<John.Doe@palm.com>, the display component of the address field value is “John” and the address portion of the address field value is John.Doe@palm.com. The address portion may be hidden, or selectively/intermittingly viewable. The display component of the address field value is also not always necessary, as the address field value may correspond to just the address (e.g. John.Doe@palm.com).

When an item, such as an address field value, is said to be “atomic”, or used in connection with a variation of “atomic” (e.g. “atomically” or “atomic state”), what is meant is that the item is indivisible for purpose of performing a state operation.

With regard to mobile computing devices, many of the features and functions described herein facilitate the user in overcoming some of the limitations normally present with such small-form factor devices. For example, embodiments described herein facilitate the user's ability to enter input for an address field value, to view the address field value, and also to view information associated with the address field value (e.g. information from an associated contact record). Moreover, embodiments described herein promote an intuitive approach for user's to communicate with desired recipients, regardless of the type of transport selected for the communication.

Methods, steps of methods, processes, sub-processes and techniques may all be programmatically implemented or facilitated by embodiments of the invention, In this regard, one or more embodiments described herein may be implemented in whole or in part through the use of instructions that are executable by one or more processors. These instructions may be carried on a computer-readable medium. Machines, devices, processors, and other programmatic components shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

machines.

As used herein, the term “programmatic”, “programmatically” or variations thereof means though the use of computer-implemented instructions. The term “logic” means any programmatic implementation, such as through computer-executed instructions or code.

System Description

FIG. 1 illustrates a system for enabling users to interact and use address fields in connection with operation of one or more messaging applications, according to an embodiment of the invention. In FIG. 1, a system 100 includes multiple messaging applications that can be operated to send different kinds of messages. In an example provided by FIG. 1, the messaging applications include an email application 110, a Short Message Service (SMS) application 120, and a Multimedia Message Service (MMS) application 130. Each of these applications are representative of a particular kind of transport, enabling handling of messages of particular types and formats for the particular application. Numerous other kinds of messaging or communication applications may be incorporated with one or more embodiments of the invention. For example, instant messaging applications, or even communication applications that involve voice data may be used with one or more embodiments described herein.

System 100 includes a library 140 of resources that are shared by the different messaging applications 110-130 for purpose of enabling use and interaction of address fields with messaging applications. In one embodiment, the library 140 includes components that include one or more of a rendering engine 162, an addressing editor 164, a lookup feature 166, and a list manager 168. Each of these components may be used and/or operated through each of the messaging applications 110-130.

In an embodiment, system 100 may have access and use of a contact database 150. The contact database 150 includes multiple contact records 152 identifying persons or entities that a user of the system 100 may exchange communications with or otherwise contact. Information that may be maintained by individual contact records 152 may include a first name, last name, company/employer name, phone number list (including home phone number, mobile number, fax number), email address, alternative email address, and instant messenger identifier. An SMS or MMS identifier other than a mobile phone number may also be specified. The individual contact records 152 may include contact record identifiers, which are displayed to identify the record in various context. In many typical cases, the contact record identifier corresponds to values provided by the field for the first name, last name or combination thereof (e.g. “John Doe”).

In an embodiment, the library 140 includes an indexer 146 that indexes data from the contact database 150. Other types of databases, record stores, and record types (e.g. event logs, calendar records) may be used in addition or as an alternative to the database or data store that the indexer 146 indexes. In an embodiment such as shown by FIG. 1, the indexer 146 generates an index 145 from data contained in individual records of contact database 150. The index 145 may associate strings of characters on different contact record field with pointers to individual records that contain those character strings on the various contact record fields. In this way, the index 145 may enable a search interface to identify individual records 152 that match search criteria specified by a user, including search criteria that is in the form of character string. Various index structures and search algorithms may be used to match contact records to search criteria. In one implementation, the character string of the search criteria is matched to select filed values of a contact record. For example, the character string may be compared to field values that, in a given contact record, correspond to a first name, last name, company name, phone number (e.g. home phone number, mobile number, fax number), email address, alternative email address, and instant messenger identifier.

In an embodiment such as shown by FIG. 1, the search interface may be provided by the lookup component 166. The lookup component 166 is configured to enable a user to enter a series of alphanumeric character entries. In response lookup component 166 scans the index 145 to identify records with field values that match the entered series of letters and numbers. The lookup component 166 (or the rendering engine 162) returns information from the contact database 150. This information may correspond to the display of select field values from individual contact records 152 that match the alphanumeric entry of the user. According to an embodiment, the information identified from individual contact records 152 is filtered to exclude fields, values or information that is not pertinent to the messaging application from which the lookup component 166 is operated. For example, if the lookup component 166 is used with operation of the email application 110, one embodiment provides that the return of matching contact records omits information from those contact records that have no use for email messages. As such, the lookup component 166 may exclude, for example, non-mobile phone numbers and the person's home address, but include field values assigned to the email addresses and the mobile number fields of the contact record.

In one implementation, the lookup component 166 enables a person to select a contact record for an address field without having to manually enter all the characters of the contact record or its recipient address. Rather, the user may enter one or more characters into a text entry field provided as part of the lookup component 166. The lookup component 166 uses the entered characters to identify from the index 145 contact records that have fields that match the entered values. The matching contact records are displayed to the user in some form, and the user can enter navigation and selection input to select a record for an address field value. When a contact record is entered for an address field value, the display component of the address field value may correspond to an identifier of the contact record. The recipient address, on the other hand, may correspond to one of the field values from the contact record identified as the address field value.

According to an embodiment, each of the messaging applications 110-130 may enable use of the lookup component 166. In one embodiment, the lookup component 166 uses the alphanumeric entry of the user to scan the index 145 for field values that are pertinent to the particular application from which the lookup component 166 is called. For example, the lookup component 166 may be called through use of the email application 110. A specific character entry causes a scan of the index 145, but only for field values that are deemed pertinent to the email application 110. These field values may be different than those scanned for another application, such as SMS application 120 or MMS application 130. In another embodiment, the field values scanned are the first name and last name of the contact record, as well as the corporate entity of the contact record. What is used as the recipient address may correspond to a field value contained in the record. This field value may be determined programmatically, based on the messaging application that uses the lookup component 166. Alternatively, multiple possible recipient address may be contained in a given contact record, and the user may need to specify which recipient address to use.

Among other functions, the rendering engine 162 affects the manner and content that is displayed with or as the address field value of a composed message. In many cases, system 100 has information about the recipient identified in the address field value of a composed message. This information may be in the form of (i) a name of the person, (ii) alternative address of the recipient, and/or (iii) information derived or contained in a contact record associated with the recipient. For example, in the case where the address field value corresponds to a name of a recipient for which there is an associated or assigned contact record, the rendering engine 162 enables other information from the contact record to be viewed by the user selecting or putting the address field value in focus. Under one embodiment, the rendering engine 162 enables the view of the additional information to take place in the presence of the composed message, so that the user can view the additional information with the address field value. For example, a fly-out window may be used to temporally display information from the contact record of a recipient to a user.

Under an embodiment, the address editor 164 enables the address field value of a composed message to be edited, even after the address field value has been established edited by the messaging application. An address field value may be deemed established when the messaging application on which the message is composed recognizes the address field value as an atomic object. As an atomic object, the entire address field value may, for example, be deleted with one action. Under an embodiment, the address editor 164 enables the address field value to be edited “in-line” on an addressed message. In other words, the address of a message (e.g. email or SMS) to a recipient can be edited on the line where the address field value was entered and then subsequently displayed, even when the address field is established as an atomic object. In comparison, many existing applications allow uses to enable the address field value after it is established, but in a separate window or display area. On small form-factor devices, the ability to perform in-line edits on an addressed messages promotes ease of use, as the small screen limits the ability to enable edits on separate windows or interfaces.

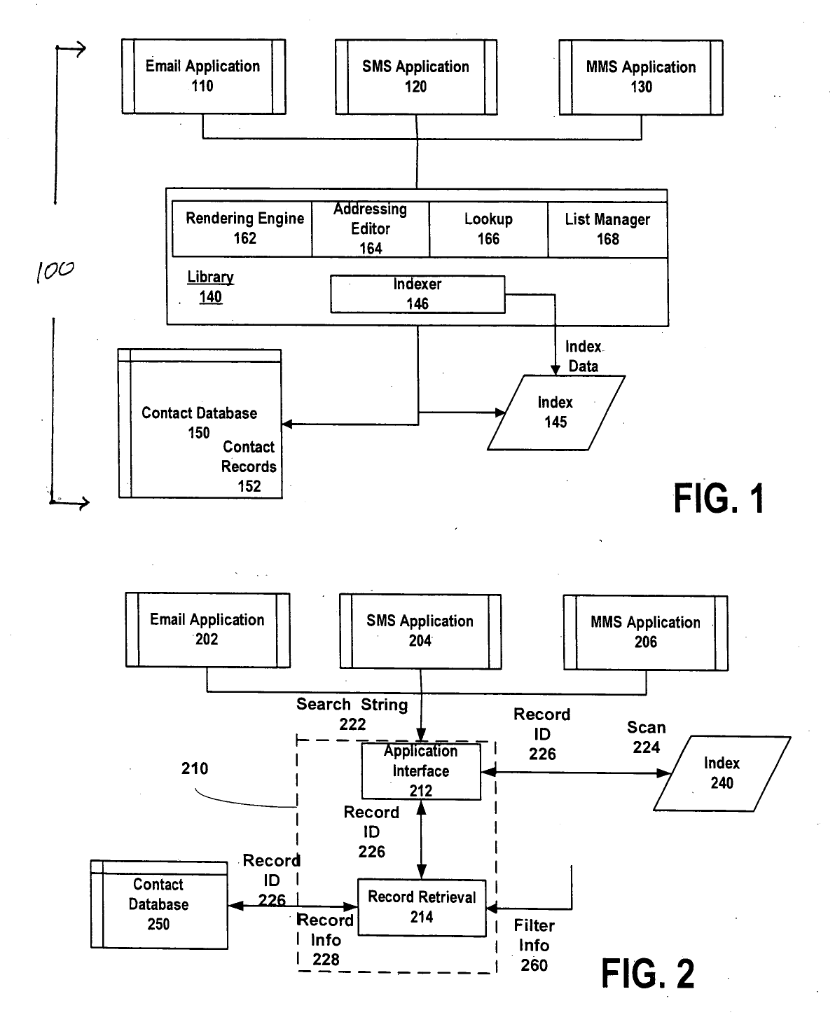

The list manager 168 is another mechanism that enables a user of the device to select an address field value without manually entering the recipient address in its entirety. As described with, for example, an embodiment of FIG. 2, the list manager 168 may maintain one or more lists, where each entry on a given list corresponds to a recently transmitted or composed message. In order to provide the address field value for a new message, the user may select to view a given list and make a selection of a list entry. In one implementation, this would provide the user with an alternative to selecting an address field value through use of the lookup component 166, or through manual entry of the entire address field value. In one embodiment, the list or lists maintained by the list manager 168 are “most recently used” lists (e.g. the ten most recently used). Furthermore, different lists, or different sets of list entries, may be provided for each messaging application 110-130 that uses the library 140. Thus, for example, the user may operate the email application 110 to view a short list of recent addresses used through operation of that application. The user may then operate the SMS application 120 to view different list entries through operation of that application.

While embodiments of FIG. 1 illustrate the library 140 shared by the different messaging components as having numerous components, other embodiments provide for fewer or more components to be shared amongst the applications. Several embodiments are described below, which may or may not be implemented with other components and functionality described with FIG. 1.

Contact Lookup

FIG. 2 illustrates a contact lookup system for use with messaging applications, under an embodiment of the invention. A contact lookup feature such as described by FIG. 2 may be shared across multiple messaging applications for purpose of enabling a user to enter alphanumeric characters in search of matching contact records. As such, components described with the lookup system of FIG. 2 may correspond to elements described with FIG. 1 (e.g. lookup component 166), which are shared amongst applications. Once matching contact records are found, the user can take the additional step of selecting a particular matching contact record, or selecting an address field value contained in one of the matching contact records. In either case, one embodiment provides that the address field value includes the contact record identifier as the display component, and an address value (e.g. mobile phone number or email address) as the recipient address of the address field value.

In an embodiment shown by FIG. 2, the lookup component 210 includes a message application interface 212 and a record retrieval function 214. The lookup component 210 may interface with a contact record database 250, as well as with an index 240. In an implementation of FIG. 2, the lookup component 210 is provided for the email application 202, the SMS application 204, and the MMS application 206, although other types of messaging and communication applications are also contemplated. Anyone of these applications may be operated to access and use the lookup component 210.

In an embodiment, the user operates one of the messaging applications to enter a search string 222 for the lookup component 210. For example, the user may use selection input on the address field to view or activate the interface 212 of the lookup component 210. On the interface 212, the user can enter an alphanumeric search string (e.g. through operation of a keyboard). The search string may correspond to, for example, (i) the first few characters of a first name or last name of a contact record, (ii) multiple characters that correspond to a combination of initials, or a combination of first and last name of a contact record (e.g. initials of first and last name, or two letters from first name, one from last name), (iii) corporate name, or (iv) other field value of a contact record, such as the field value of one of the address fields.

Under one implementation, the following lookup rules may be applied to a given search string: First two letters that are entered are matched as follows: (i) First name, last name (ii) Last name, first name, (iii) First name only, and (iv) Last name only. The third letter is interpreted as follows: (i) Next letter in first name, (ii) Next letter in last name only, (iii) Second letter in last name (first letter matching first name).

Numerous lookup algorithms may be employed with embodiments described herein. In particular, the algorithms may be shared or distributed through a library and interface that is shared by multiple messaging applications. Another lookup algorithm provides for the use of a space character between two characters in an input sequence. When no space character is present, the lookup algorithm matches a sequence of two or more characters based on the following: (i) first initial/last name, (ii) last initial/first name, (iii) first name, and (iv) last name. However, if there is a space character (and the space character does not match a space character in either the first or last name), then the space character is used as a delimiter between first and last name. For example, the search sequence “bob jo” can match “Bobby Johnson” or “Bob Jorkney” or “Joe Bobanson”.

Furthermore, while the lookup component 210 may be shared by the different messaging applications, the functionality of the lookup component 210 may be tailored for the particular messaging application. For example, when email application 202 is operated in connection with the lookup component 210, the string 222 may be compared against field values for email addresses. As another example, if the messaging application that uses the lookup component 210 is an instant messaging application, the reverse lookup of the characters may be directed towards a field value that is known to provide an instant messaging identifier.

The interface 212 may receive the search string 222, and submit perform a scan 224 or search of the index 240 using the search string 222. In one embodiment, the index 240 is structured so that the search string 222 implements a search protocol, defining what fields are to be searched, and how the search string 222 may be divided or sequenced to match a given field value. For example, two characters that are letters may be searched against (i) first two characters of the first names, (ii) first two characters of last names, or (iii) initials of first name and last name. Two characters that are numbers may be searched against fields that are phone numbers only. In this way, the index search may carry over different combinations of the search string 222 to identify matching records from the contact database 250. The identification of the records may be carried to the interface 212 in the form of identifiers 226 of contact records that were deemed to be matching. Record identifiers 226 are communicated to the record retrieval function 214, which locates the corresponding records from the database 250. The record retrieval function 214 may then inspect individual records and retrieve record information 228 from those inspected records. The record information 228 is then displayed to the user. In an embodiment shown by FIG. 2, the record information is displayed to the user by the rendering engine 162.

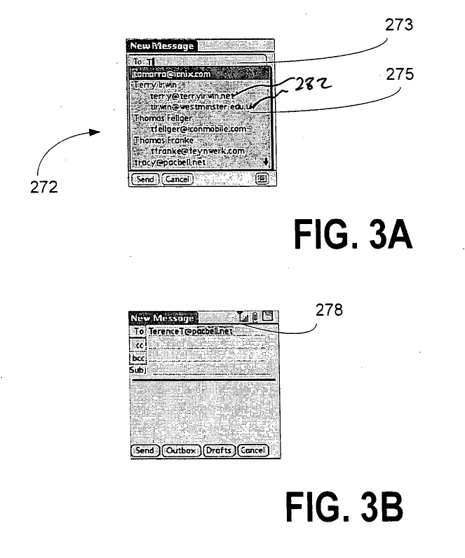

When the user interacts with the lookup component 210, the user may be provided a choice of selecting a contact record for insertion of an address field value in a given message, or alternatively viewing information from the contact record identified from the index 240. FIG. 3A-FIG. 3B illustrate an implementation of the use of lookup component 210 in connection with a messaging application. In FIG. 3A, a view 272 of an open, unaddressed message is presented to the user from which the user can address a message, provide a subject line and/or compose a body. An address field 273 is shown that the user can address the message, although more than one address field can be used (e.g. “CC” or “BCC”). The lookup component 210 may be initiated by the user entering characters in the address field 273, and/or by the user selecting the address field (“TO”).

In an implementation shown, after each character entered by the user in the address field, that character, in combination with any preceding characters, is scanned against the index 240 to identify matching contact records. With the input of each character, the number of matching results is reduced. addressing of the message by entering the string 222 on the address field.

In FIG. 3A, a fly-out window 275 is displayed in response to the user's character entry. The window 275 may display contact records identifiers 282 that match the user's input in the address field 273. The rendering engine 162 may display the window 275 in response to the character entry. In addition to the contact records identifiers, the record information 228 may displayed in the form of field values 283. In one implementation, the user can scroll or navigate in the window 275 to see additional record information. The user can also select a contact record, and/or one of the field values 283 displayed with one of the contact records in the window 275.

FIG. 3B illustrates the result of the user selecting an address field value from the window 275. In one implementation, the user selects a contact record identifier, and then the recipient messaging identifier for use with the message is automatically selected by some selection rule (e.g. “always use the email address, unless specified otherwise”). In another implementation, the user specifies one of the field values, such as the mobile number of email address contained in the record information for a particular contact record. In response, the recipient messaging identifier portion of the address field value is provided or based on the selected field value. The display component portion of the address field value may or may not correspond to the contact record identifier. In the example provided by FIG. 3B, the address field value 278 corresponds to the recipient address.

With further reference to FIG. 2, an embodiment provides that a set of filter rules 260 influence or control what portion of the record information 228 is displayed from interface 212 so that record information 228 is pertinent to messaging. For example, certain fields may be assumed to not be pertinent to messaging: email addresses and mobile phone numbers. Other fields may be assumed to not be usable as recipient messaging identifiers: home phone numbers, mailing address, title, notes, fax number. The filter rules 260, when implemented, cause the record information 228 to be filtered so that when it is rendered to the user, what is displayed are field values that can be used as addresses for messaging applications. In one embodiment, the filter rules 260 may be based on what application is running, so that the displayed field value provides an address or identifier for that particular application. For example, for an instant messaging application, the displayed record information may omit all field values for phone numbers and messaging, but for the instant messenger identifier of the intended recipient.

In this way, the lookup component 210 allows the user to (i) quickly specify, through a small set of alphanumeric entries, a contact record identifier as an address field value, and (ii) have the recipient address determined and inserted for the address field value, either automatically or through selection/navigation input. Under one embodiment, the user does not have to enter the entire recipient address, or even know what the recipient address is when entering the address field value. The user may simply rely on knowing the name of the person who he wishes to contact, and the recipient address can subsequently be identified programmatically when the contact record is identified. or by the user (through navigation/selection input).

Most Recently Used Lists

Embodiments described herein enable the use of one or more lists in connection with operation of the some or all of the messaging applications that can be operated on a computer or mobile computing device. In particular, one or more embodiments provide for a most-recently used (“MRU”) list to be associated with different messaging applications. The MRU list may be maintained separate from the contact database, and provide the user with another alternative means by which an address field value can be selected for a message.

In one embodiment, a MRU list is updated with the transmission of individual messages from a given outgoing message. For example, when a message is transmitted from a mobile computing device, each recipient address of the outgoing message is added to the MRU list for that application. The new entries take the place of old entries, so that the MRU list reflects recent communications.

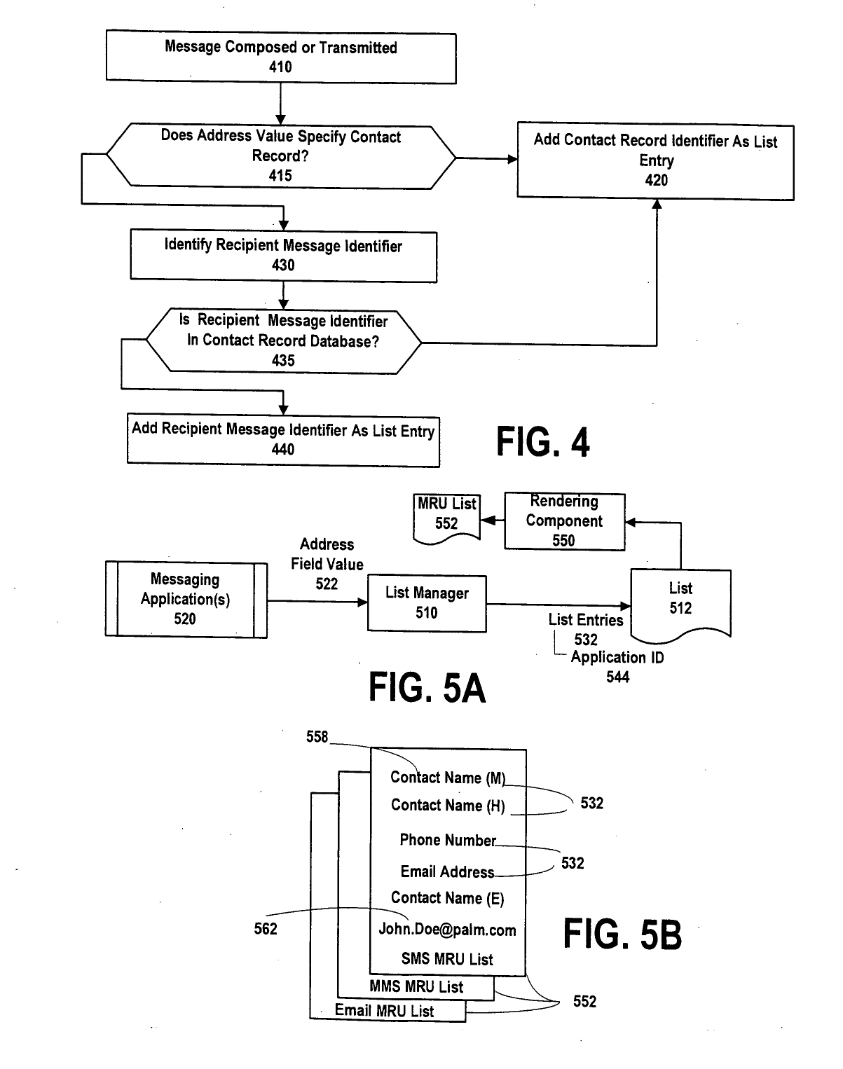

FIG. 4 illustrates a method for maintaining an MRU list, under an embodiment of the invention. A method of FIG. 4 is described in the context of a mobile computing device, such as one that transmits and receives data over cellular networks. However, other embodiments may implement a method such as described with other kinds of computers.

In step 410, a message is composed or transmitted from the mobile computing device. The message may be transmitted using anyone of many messaging applications that can be operated on a computing device, including an email application, an SMS application, an MMS application, or an instant messaging application.

In step 415, a determination is made as to whether an address field value of the composed or transmitted message specifies a contact record stored on the mobile computing device. For example, the user may spell out an email address, not realizing the email address is in a contact record.

If the determination in step 415 is that the address value of the outgoing message does specify a contact record, then a list entry corresponding to the contact record identifier is added to a MRU list in step 420. While the list entry may be displayed as the contact identifier, but some designation may be made as to which field value of the identified contact record contains the recipient address of the outgoing message.

In some cases, the address field value of a message may specify a contact record identifier, in which case the recipient address may be contained by that record. In other cases, the address field value displays only the recipient address, and this identifier may or may not correspond to one of the contact records. If in step 415, the address field value does not display or correspond to a contact record identifier, then in step 430 the recipient address is identified. A determination is made in step 435 as to whether the recipient address has correlation to one of the contact records. For example, functionality described with the lookup component 210 (FIG. 2) may be used to perform a reverse-look up operation, where the address of the transmitted message is compared against field values of the contact records stored on the mobile computing device. The index 240 may also be used to identify field values in contact records having the message.

If the determination in step 435 is that there is correlation between the recipient address identified in step 430 and one of the contact records, then step 420 is performed, where the list entry is made with the contact record identifier that contains the recipient address. Otherwise, in step 440, the recipient address is used as the list entry.

FIG. 5A illustrates components for implementing a method such as described with FIG. 4, according to one or more embodiments. In an embodiment, a list manager 510 may maintain and update a list 512. The list manager 510 may be incorporated into the shared library 140 to maintain the list for one or more of the messaging applications 520. The list 512 that is maintained and updated by the list manager 510 may be maintained in a manner similar to the index 145. Specifically, the list 512 may be maintained in RAM, where it is permanent, unless there is a hard reset event.

In an embodiment such as described with FIG. 1, the list manager 510 may be shared by multiple messaging applications 520. The messaging application 520 may correspond to, for example, email, SMS, MMS, or instant messaging applications. When an event corresponding to a message transmission from the particular application 520 occurs, the application supplies the list manager 510 with the address field value. As mentioned with an embodiment of FIG. 4, the address field value may include either a contact record identifier, a recipient address that has a corresponding contact record identifier, or a recipient address that has no corresponding contact record identifier. Accordingly, the list manager 510 may perform a method such as described with FIG. 4 to determine a list entry 532, so that each outgoing message generates at least one list entry. The list entry 532 may correspond to either a contact record identifier or a recipient address. In order to maintain and update the list, the list manager 510 forwards each list entry 532 to a master list 540.

The list manager 510 may also include an application code or identifier 544 that identifies the particular messaging application 520 that generated an individual list entry 532. The application code 544 enables master list 540 to be a source from which different MRU list 552s can be generated for each of the messaging applications 520. The application code 544 enables subsets of list entries 532 to be identified from the master list 540. Each subset of list entries 532 may be presented as a separate MRU list 552 that can be called from one of the corresponding messaging applications 520. Thus, for example, the recipient address of an SMS message and of an outgoing e-mail message may each form separate list entries 532 on the master list 540, but each of the recipient address has a different application code 544 which identifies the particular list entry as belonging to the SMS messaging application or email messaging application respectively.

In an embodiment, the rendering component 550 may be used to identify subsets of list entries 532, and to form MRU list 552s from those list entries for use with individual messaging applications 520. The rendering component 550 may correspond to the rendering engine 162 of the library 140, which is shared by the different messaging applications 520.

With the operation of a given messaging application, an embodiment provides that the rendering component 550 enables each generated MRU list 552 to be used to perform one or more of the following: (i) view address field values of recent or most recent outgoing messages using the given messaging application; (ii) when applicable, view the contact record information associated or identified by the actress field value, and enable the user to select recipient address from the displayed record information; (iii) select a recipient address for a new outgoing message, using either the message recipient identifier that corresponds to the list entry, or one of the recipient address that is included in a contact record identifier by the list entry.

In this way, an embodiment provides that each list entry 532 is an actionable data item, in that selection of the list entry may result in different operations being performed. In one embodiment, a full selection of a list entry (e.g. double click) results in an underlying address of the list entry being inserted into the address field of a new message. A partial selection (e.g. placement in focus) of a list entry that corresponds to a contact record identifier results in record information from that contact record being displayed to the user. Thus, individual list entries may be used to address messages and view information such as contact record information (as the case may apply).

As described by one or more embodiments, the address field value identified by each list entry 532 may also be subjected to a view and edit operation by the user. The edit to the address field value may be performed “in-line” on the message. Furthermore, if the list entry 532 identifies a contact record, the edit of the address field value may cause the rendering component 550 to not display the identifier of the contact record, depending on whether the edited recipient address is an existing field value of that contact record.

FIG. 5B illustrates MRU lists 552 for different messaging applications, under an embodiment of the invention. A separate MRU list 552 may be maintained for the email application, the MMS application, and the SMS application. Each MRU list 552 comprises multiple list entries 532. The number of list entries 532 on each list 552 may be designated at some number (e.g. 10), so that the addition of each list entry 532 to the MRU list means the oldest list entry is dropped from the MRU list 552. As described with FIG. 4, individual list entries may be displayed as contact record identifiers 558, or recipient addresses 562. In the case where a given list entry 532 displays a contact record identifier, an additional code 564 indicates which field value from that contact record was used as the address of the outgoing message.

Lookup Using Combination of Contact Database and MRU List

Under an embodiment, the contents of the list 540 (FIG. 5) may be made available to the lookup functionality, so that when a lookup operation is performed, the sources checked include both the contact record database 250 and the list 540 (or alternatively one or all of the MRU lists 552). Thus, for example, with reference to FIG. 2, when an individual enters the search string 222, the data sources checked by the lookup component 210 include the index 240 (which points to the contact database) and the list 540.

In one embodiment, different protocols may be used when checking the list 540, as opposed to the contact record database 250. This may be a result of the use of the index 240 when checking the record database 250. As described above, matching the search string 222 to a contact database may include (i) matching a first character to a first name, and a second character to a last name (initials search), or (ii) a reverse address lookup. Under one implementation, for example, when the search string 222 is used against the list 540, neither the initial search or the reverse address lookup are performed. Thus, different search or matching algorithms may be used to match one search string to address field values and contact records from two different sources: the contact record database 250 (via an index 240) and the list 540.

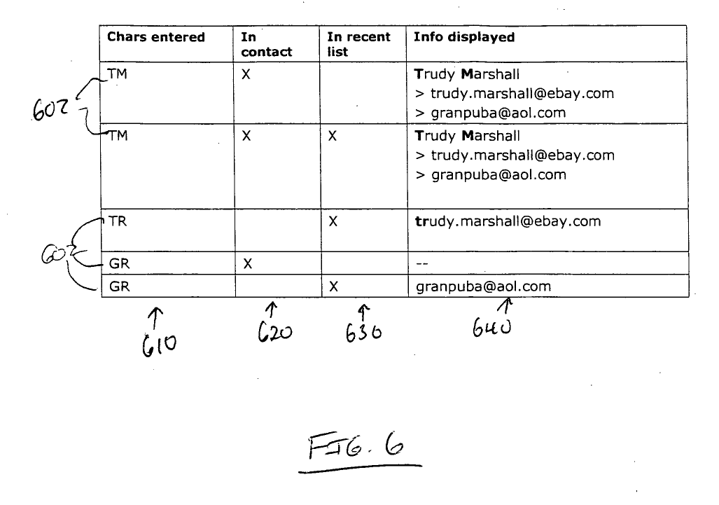

FIG. 6 is a table that illustrates how a search string value can be used to identify address field values from both a contact record database and a MRU list, under an embodiment of the invention. In the table, a far left column 610 represents a search string value 602. Adjacent middle columns 620 and 630 show the source (contact database or MRU list) from which a match to the search string value 602 was found. A far right column 640 shows rendered results 612 of the lookup function as a result of searching against the contact database and the MRU list. The rendered results 612 may be provided by the rendering engine 162 (FIG. 1). FIG. 6 illustrates several examples of how lookup functionality can be integrated with the MRU list, and the configurations and scenarios presented should only be considered as optional features or configurations.

In the first case (top row), a matching result is found in the contact records. The search string value 602 is used to identify a contact record identifier (first name, last name). The protocol permits the search string value 602 to be used to identify initials, or the first letter of the first name and last name. In the second case, the MRU contains a contact record identifier as a list entry. The search of the list entry and the contact database yields the same result. In an implementation such as shown, the lookup component knows that certain protocols, such as first initial last initial search, apply to all contact record identifiers in the search domain, regardless of whether the contact record identifier is in the MRU list or in the contact database. Since the same record is found from each source, the result looks the same as the first case.

In the third case, the search string value 602 is changed so that it only matches one of the email addresses of the contact record shown. The third case illustrates an implementation in which email addresses are only searched as part of the lookup functionality when the email addresses are one of the list entries for the MRU list. In order to be a list entry, the email address is either not present in any contact records of the database, or the list manager is configured to not convert email addresses and other recipient address to contact record identifiers. In either case, the result that matches the search string value 602 is only in the MRU list, and the lookup component in the case provided does not search email addresses or other field values of individual contact records. Thus, no contact record exists for the search string. However, list entries in the MRU list corresponding to recipient addresses may be searched to find the matching result. Thus, when list entries of the MRU list display addresses, those addresses may be searched. The fourth case illustrates an implementation where the search string value is only used to search contact record identifiers of the contact database, and not other field values, such as email addresses in contact records. As such, if one of the contact records has a field value (email address field) that matches the search string value, but the list entry does not use that address, the search string returns no results.

With regard to the examples provided by FIG. 6, it should be apparent that numerous variations and alterations are possible. As shown by FIG. 6, however, for a given search string, the following may apply: (i) both the MRU list and the contact database may be searched, (ii) list entries may contain either contact record identifiers or recipient address, (iii) different rules may apply to searching contact database as opposed to MRU list, and/or (iv) different rules may apply to searching a contact record identifier as opposed to a list entry that corresponds only to a recipient address.

Delimiter Insertion

With addressing, delimiters indicate when one address field value ends and another starts. When addresses multiple recipients on one message, the addresses provided for each recipient may be delimited by a character such as a semi-colon or comma.

With mobile devices and other small-form factor devices, the insertion of delimiters is typically a multi-step effort. Even with small form-factor devices that offer QWERTY keyboards, the character that designates the delimiter is often an alternative mode of another key. With devices that use a numeric keypad layout (such as those that use predictive text), delimiters can be even more difficult to find and use. With regard to small form factor devices in general, fewer key strikes and input actions is preferred, particularly in address messaging.

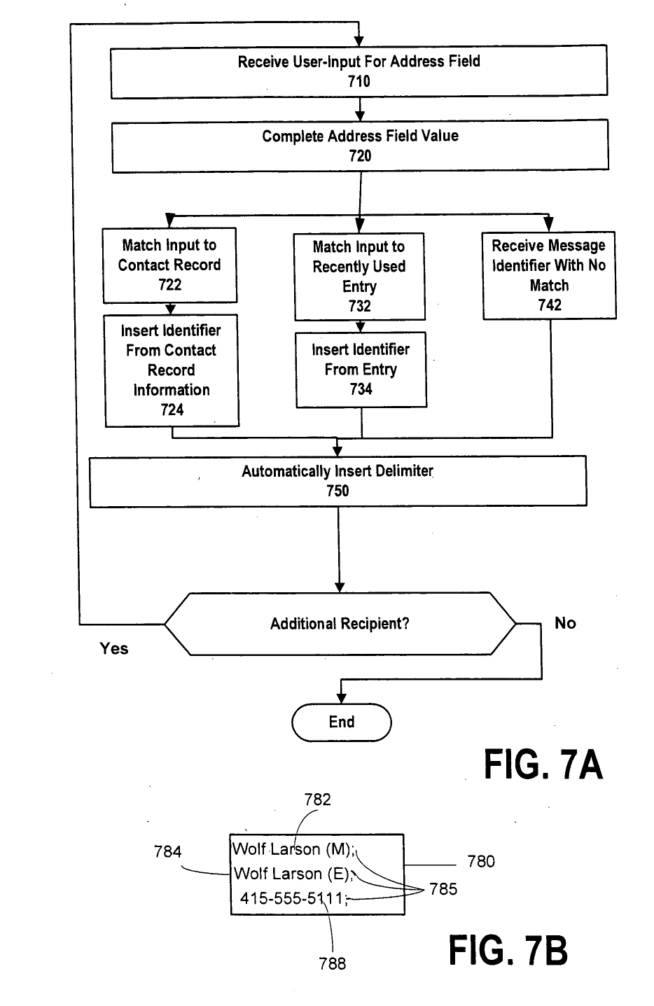

FIG. 7A illustrates a method in which the delimiter for an address of a message is inserted automatically, at least in part, once the address field value for the message is determined. A method such as described with FIG. 7A may be used with any of the embodiments described elsewhere in this application. For purpose of illustration, a method of FIG. 7A is described in the context of a system such as shown and described with FIG. 1. As such, reference to elements of FIG. 1 is intended to describe only a suitable element for performing a step, sub-step or action being described.

In step 710, user-input for an address field is received. The input may be in the form of selection input, such as through use of lookup functionality, list entry selection of an MRU list, or other operation where the user selects a data item corresponding to the desired address. As an alternative option, the input may also correspond to character entry, where the user spells out, for example, an email address or mobile phone number as the recipient location for a message. As described elsewhere, the input that the user selects for the address field may not necessarily correspond to the message address, but rather invoke the message address by association. For example, the input may identify a contact name (e.g. name of recipient), rather than the actual message address in long form.

In step 720, the address of the message is identified as being complete. The message address may be specified in one of several ways. Some of the possible ways in which the message address is identified are completed are shown with the sub-steps described below.

Sub-steps 722 and 724 provide that the user-input specifies or selects a contact record, and an address from the specified or selected contact record is then inserted for the address field of the message. A contact record may be specified by the user performing a lookup using a small number of search strings. The contact record may also be selected using navigation or other features where the contact record identifier is displayed or the contact record is made available. For example, the user may specify a name of a person to look at that person's contact record, then the user may select the mobile phone number from that contact record.

Sub-steps 732 and 734 provide that the user's input specifies or selects a list entry from one of the MRU lists, then the address identified by the selected list entry is inserted in the address field of the message. Under one implementation, specification of the list entry also automatically select an address, even when the list entry specifies a contact record.

Sub-step 742 provides for the case where the user spells out the address or contact identifier for use as an address field value. For example, the user may enter each character of an email address, mobile phone number, or contact name.

Following step 720 and the sub-steps by which the message address is identified and completed, step 750 provides that the delimiter used by the particular messaging application is automatically inserted after the completed message address. For example, some messaging applications use a semicolon, while others a colon.

In step 755, a determination is made as to whether the user wishes to enter another address for a message. Under one embodiment, the automatic placement of the delimiter in the address field results in the cursor or prompt to be positioned just after the inserted delimiter, so that the next addressee of the same message can be specified without the user having to enter a space or otherwise position the cursor on the display.

If there are no additional addressee's for the message, the method is done, and the address field is complete. Otherwise, it the user has additional addressees, the method returns to step 710, where the user enters input to specify or select the next address for the outgoing message.

In an embodiment such as shown by FIG. 1, the delimiter insertion is performed by the rendering engine 162. The logic that inserts the delimiter may also count the number of delimiters that are used in a given message, to ensure that no delimiter is automatically inserted in the address field when the maximum number of addressees permitted by the application are provided for in the address field of the message.

With regard to an embodiment of FIG. 7A, many messaging applications (particularly on cellular devices) have a limit (“n”) as to how many addresses can be included in one email. In such cases, there is only n−1 delimiters that can be inserted into one address field. In an embodiment, the number of delimiters is counted after step 750. As a precursor to step 750, a determination is made as to how many delimiters are present (or whether more addressees can be included after insertion of one more delimiter), and if another addressee of delimiter cannot be inserted, the method ends without re-performing step 750.

FIG. 7B illustrates an address field 780 on which addresses can be inserted, using an embodiment such as shown by FIG. 7A. In FIG. 7B, the user specifies a mobile number 782, an email address 784, and an alternative phone number 788. The mobile number 782 may be selected by the user looking up or otherwise selecting the contact record for “Wolf Larson”. Subsequent to the selection, the delimiter 785 is programmatically and automatically inserted after the first entry. In an example provided, the email address 784 may be selected or identified from the contact record for “Wolf Larson”. The act of selecting an address field value from a list or other presentation causes automatic insertion of the delimiter 785. Another instance of the delimiter 785 is programmatically and automatically inserted after the second entry. With the alternative phone number 788, the delimiter 785 may be inserted by any of the following: (i) a programmatic determination that the address provided is complete-for example, upon ten numbers being inserted (in a domestic phone number), the delimiter 785 may be inserted automatically; (ii) the user may perform some action or trigger (other than a character input that specifies the delimiter) to insert the third delimiter. For example, the user may press selection input after completing the phone number to trigger insertion of the third delimiter 785. Under one embodiment, the delimiter may be inserted automatically or by trigger until the addition of another addressee for a given message is not possible to limits imposed by the messaging application.

Viewing Information Associated with Message Addresses

In many cases, a n address field value may have information associated with it. For example, as described with other embodiments, the address field value may correspond to a contact name, in which case the associated information includes information contained in the contact record. The address field value may also include a message address without a contact name, in which case associated information may include the contact name, or the known name of the recipient identified by the message address. Sometimes, the address field value is an abbreviated name or moniker for a person, and the additional information identifies the person's full name and/or message address. Still further, numerous other kinds of information may be stored or maintained to be associated with a given recipient. For example, information that is associated with a message address may correspond to the last message sent to the user, or time and date of the previous communication to that recipient.

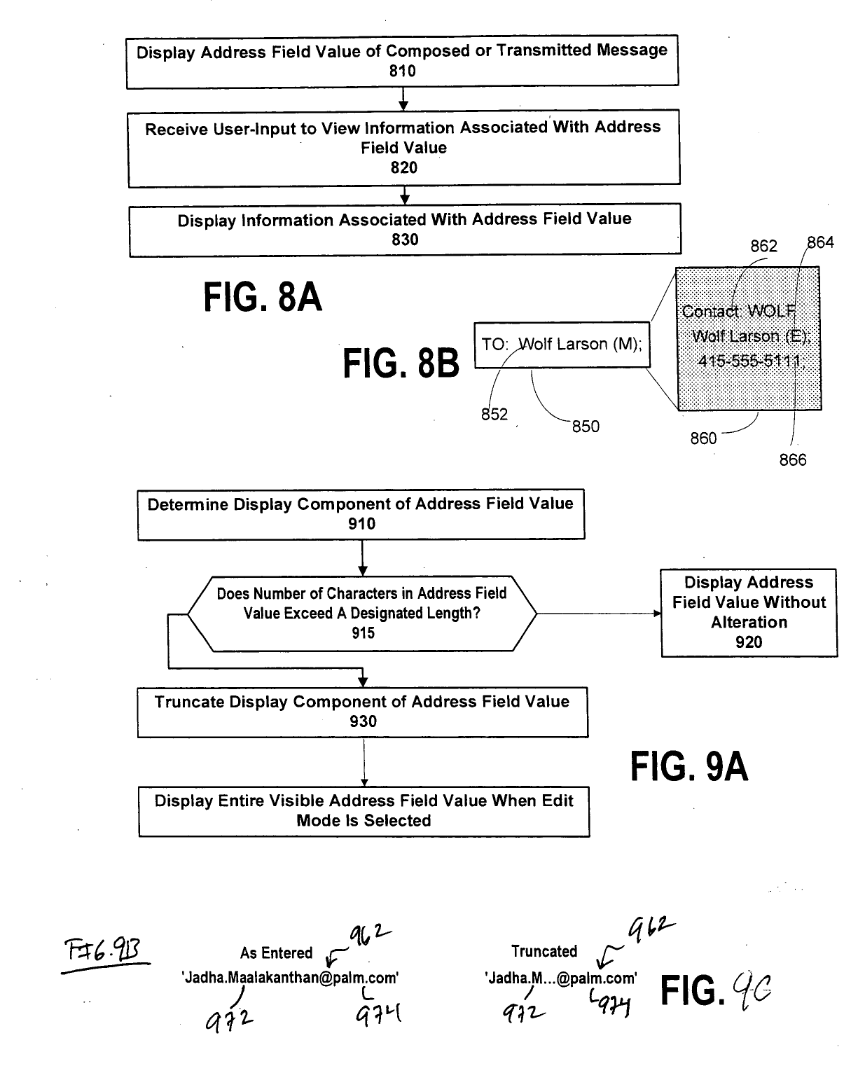

FIG. 8A illustrates an embodiment in which an address field value is placed in a selected or partially selected state for purpose of displaying or enabling the user to view information associated with the address field value. An embodiment such as shown and described with FIG. 8A may be described in the context of a system such as described with FIG. 1. As such, reference may be made to elements of FIG. 1 for purpose of illustrating a suitable component for performing a step, sub-step, or operation being described.

In step 810, an address field value of an addressed, transmitted or stored message is displayed. For example, the user may complete addressing an email, or the user may select to view addressing information from an email in an sent folder or inbox folder.

Step 820 provides that input is received indicating that the user wishes to see information associated with the address field value. In one implementation, the detection is of input that places a given address field value in a selected or partially selected state. For example, the user may place in focus an address field, so that the address field is highlighted. In a focus state, additional input may cause further actions to be performed. For example, another selection input following placement of the address field value into the focus state may cause the address field value to be lost its atomic state and to be placed in an editing mode.

In step 830, information associated with the address field value is displayed. For example, in the case where the address field value corresponds to a contact name, placement of the address field value in focus causes information from the corresponding contact record to be displayed.

In one embodiment, the user's input to select viewing additional information is a lookup operation. The lookup component 166 may retrieve contact record information for a contact name identified in the address field. The rendering engine 162 subsequently displays the contact record information.

In one or more embodiments, the information displayed from the contact record is centric, or at least pertinent to the messaging application that the message being addressed is generated from. Thus, for example, when the message is an email, the contact record information displayed shows field values that are legitimate email addresses. This may exclude non-mobile phone numbers, fax numbers, and home numbers. In order to display pertinent or centric information, one implementation provides for use of filter rules 260 in connection with the lookup component. In another implementation, the contact record information shows field values likely to be pertinent to the user from the given application. Thus, for the email application, while the user may be able to send an email to a mobile phone, the user is more likely to want to send the email to an email address, as transmission between phones is likely to be in the form of an SMS or MMS communication.

FIG. 8B illustrates an implementation of FIG. 8A, under an embodiment of the invention. In FIG. 8B, an address field 850 includes an address field identifier 852 represented by a contact name. The contact name 852 has associated with it information from a corresponding contact record. The user may provide input to indicate a desire to see information associated with the address field value (e.g. place the address field identifier 852). In response, a window 860 is generated in which select information from the record of the contact name is displayed. The information selected for the contact record may be information that is most pertinent to the use of the particular messaging application. For example, when the email application is in use, the address field information from the contact record may display alternative email addresses when the address field is provided. In the example provided, the contact name 862, an email address 864 and a mobile number 866 (which may receive email messages) are displayed.

Truncation

With small form factor computing devices in particular, long message addresses can be difficult to view. If an email address exceeds the length of the line provided for an email address, one conventional approach is to allow the email address to run onto a second line. This makes the email address difficult to view.

FIG. 9A illustrates a method for truncating an address field value of a message, under an embodiment of the invention. In step 910, the display component of an address field value is identified. In the case where the address field value corresponds to the actual message address, the display component of the address field value is the message address. However, embodiments may also apply to the case where the address field value corresponds to a contact name.

In step 915, a determination is made as to whether the address field value exceeds a designated length. In one embodiment, the number of characters that form the address field value are compared against a number indicating the need to distribute the address field value on more than one line. The designated character number may be a static designation, meaning the number never changes. Alternatively, the designated character number may be dependent on the particular usage and conditions. For example, the display window where the address is being composed may be made smaller by the preference of the user. Alternatively, an embodiment may take into account the fact that another message addresses is present on the same line, and that it may be preferable to place all addresses on one line.

In other implementations, the determination of the length of the message address may be based on factors other than character count. For example, other implementations may utilize screen position, or measure a physical length of the message address.

If the determination in step 915 is that the address field value does not exceed a size limit, then step 920 provides that the address field value is displayed with no alterations or truncations. Otherwise, in step 930, the display component of the address field value is truncated. In one implementation, this corresponds to the message address (e.g. the email address). Other implementations may provide for the contact name to be truncated. Truncation may follow rules or protocols, so that preferred information about the address message is viewable.

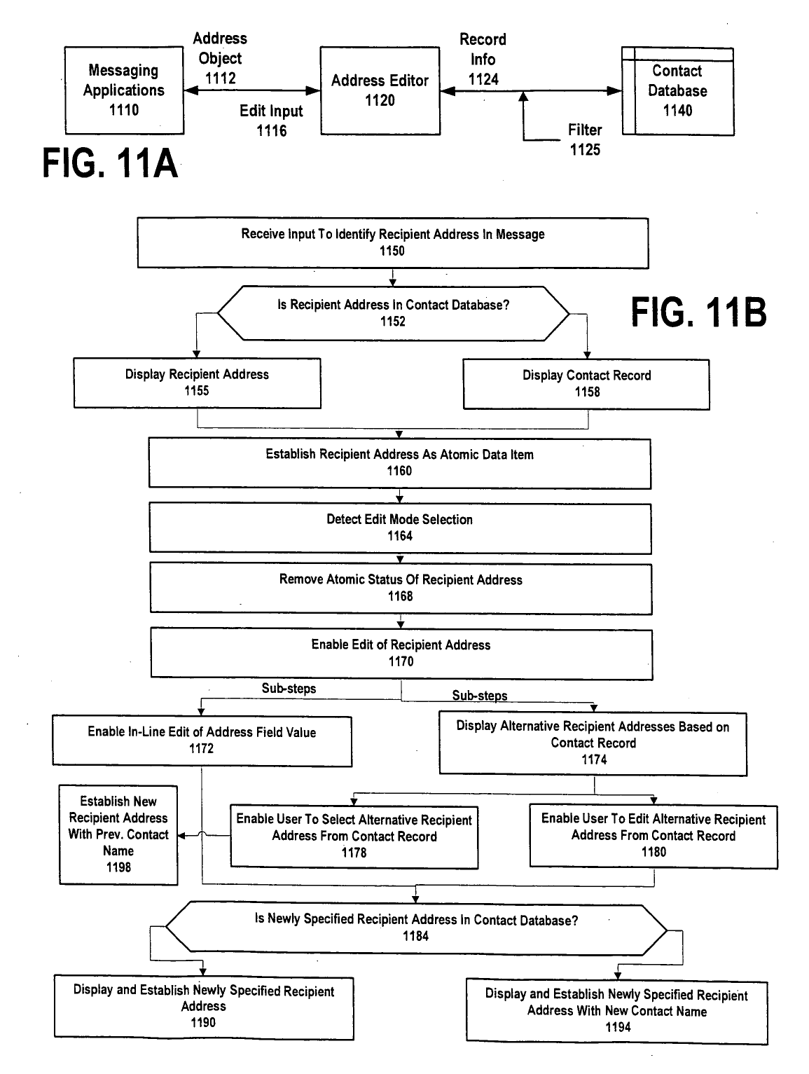

In some cases, the user may wish to enter a message address. Numerous techniques exist to enable the user to edit the address field (see FIG. 11A and FIG. 11B). An embodiment recognizes that in an edit mode, it is better to display the entire address field value to the user. Accordingly, as an optional and occasional step, step 940 provides that if the address field value is placed in an edit mode, the message address is displayed in its entirety.

FIG. 9B and FIG. 9C provide an illustration of a truncation of an address field value, under an embodiment of the invention. In one implementation, truncation is performed for the case where the address field value is a recipient address. An implementation shown by FIG. 9B and FIG. 9C provide for the case where the recipient address is an email address. In FIG. 9B, the address field value corresponds to an email address 962, having a name component 972 and a domain portion 974.

One or more embodiments recognize that people with multiple email addresses often have the same or similar name component on each of their email addresses. For example, individuals often use a combination of the first name or initial and their last name, and carry this name component from email account to email account. In truncating an email address that is too long, embodiments recognize that often, the portions of the email address most important to identifying an email address is the portion of the email address that represents the domain and the portion of the email address that represents the first few characters of a person's name.

FIG. 9B illustrates an untruncated email address, in which the name component 972 is longer than normal. FIG. 9C illustrates the same email address 962 truncated, so that it can be viewed on one line, or otherwise fit to accommodate a given space. Truncation can be rendered in numerous ways. For example, an abbreviated symbol may be used to indicate truncation occurred. Such a symbol may correspond to ellipses “. . . ” or other characters. Still further, truncation may correspond to a simple removal operation, with no characters indicating truncation occurred. With reference to an embodiment such as described with FIG. 1, the rendering component 162 may be used to perform the truncation.

In implementing truncation, one or more truncation rules may be applied to enable viewing of an email address in an addressing field. In one embodiment, the truncation rules provide that what is truncated first (as a priority) is the portion of the name component 972 that can be assumed to be attributable to letters of a person's last name. The last name portion of the name component 972 is truncated thus truncated before truncating any other portion of the email address 962. This may be achieved in one of the several ways, such as: (i) truncate from the character just left of the “@” delimiter until the email address is of a size that can be accommodated in one line; (ii) seek and identify a first name/last name delimiter (“.” or “_”), then truncate based on identifying that delimiter.

If truncating the last name portion of the name component 972 does not provide enough space, an implementation provides that the name component 972 is further truncated. This means that the domain component 974 is last to be truncated, if at all.

Embodiments described with FIG. 9A and 9B may be implemented with different kinds of messaging applications, and with messages in various stages or states. For example, one or more embodiments described above may be implemented on an email in an open state (including in a state of composition), or to an email listed in a folder (inbox, sent item). Furthermore, embodiments described above may be implemented with types of messages other than email.

Address Field Viewing

There are various instances when a person using a mobile computing device, for instance, wishes to view contact information for a particular person. In integrating contact record identification and functionality with messaging applications, users are more prone to view contact record information about a person. With many conventional approaches, the user has been required to operate a contact application that directly interfaces with the database of contact records. While this approach is effective, it typically resulted in the person losing the application view he had in order to view the contact information. Moreover, with many past approaches, the information displayed included some items that were not pertinent to the user's task at hand.

One or more embodiments described herein provide for the viewing of contact record information from address field values that include contact names. In particular, one or more embodiments provide for displaying contact record information to the user in response to some action that user performs on the address field or its value. The information is displayed with minimal interference to the user's operation of the messaging application from which the contact record information was requested.

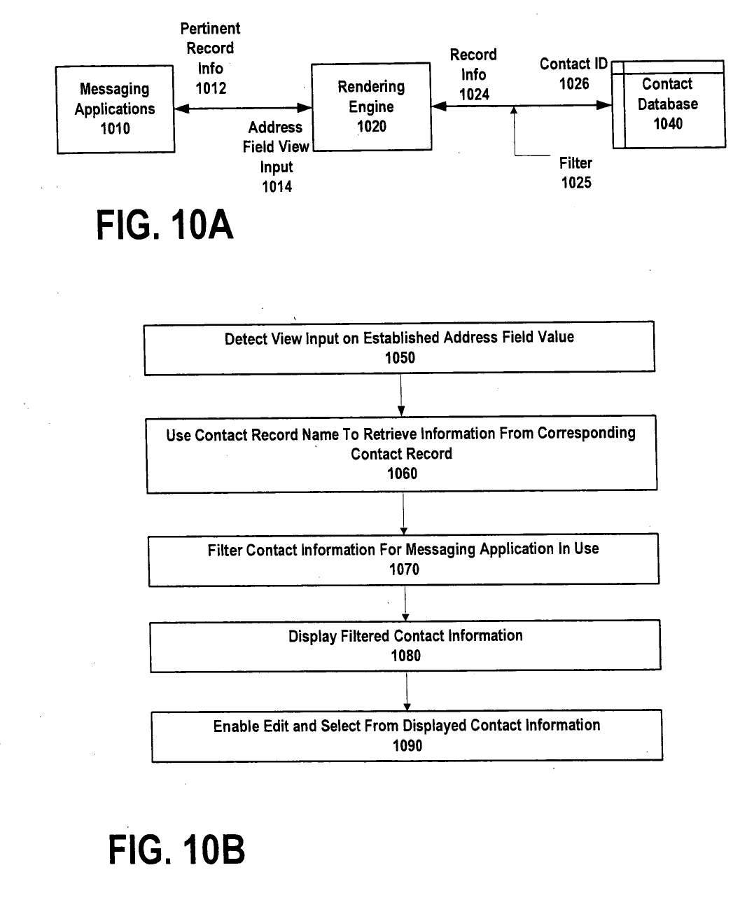

FIG. 10A illustrates components for enabling the viewing of contact record information from an addressed field of a messaging application, under one or more embodiments of the invention. In FIG. 10A, a messaging application 1010 communicates with a rendering engine 1020. The rendering engine 1020 may be one the resources in a library that is shared amongst different applications. As such, under one implementation, a system such as described with FIG. 10A may be implemented through the system 100, as described with FIG. 1, with the rendering engine 1020 having correspondence to the rendering engine 162 of FIG. 1.

In one embodiment, the messaging application 10 (e.g. email application) may be operated by a user who enters or selects a contact name for the address field value. The user enters view input 1014, which is communicated to the rendering engine 1020. By way of example, the input may be in the form of the user entering selection input (e.g. through use of a multi-directional member) on an address field, causing a contact name that appears as the address field value to appear in focus. With specification of the contact name 1025, the rendering engine 1020 is able to identify and retrieve record information 1024 from a contact database 1040. The record information 1024 may be filtered with rules 1025, either by the rendering engine 1020 or by another component that assists the rendering engine 1020 (e.g. a lookup component) is retrieving the record information. The filter rules 1025 may remove information from the contact record that includes field values that are not pertinent for use of the messaging application 1010. For example, in the case of email, home phone numbers are removed from the information in the contact record.

In response, the rendering engine 1020 then displays pertinent record information 1012 to the user. When messaging application 1010 is email, the pertinent information 1012 may correspond to the legitimate email addresses that the contact record specifies for the particular name.

FIG. 10B illustrates a method for enabling the viewing of contact record information in connection with a displayed address field value, under one or more embodiments of the invention. A method such as described with FIG. 10B may be used in connection with, for example, a system such as described by the system of FIG. 10A. Accordingly, reference to elements of FIG. 10A, or any other figure, is intended to show only suitable elements, components or functionality for performing a given step, sub-step or operation.

In step 1050, view input is detected by the messaging application 1010. In one embodiment, the view input is detected on an established address field value. An established address field value is one that the messaging application 1010 recognizes as an atomic data item. For example, when a user enters an address field value, the messaging application 1010 waits until a determination that the address field value is complete. Then it underlines the address field value (or performs some other display rendering). From that point, the data item may be treated atomically, or as a single data item.

In step 1060, the contact record name is used to retrieve information from a corresponding contact record. In one embodiment, the contact record name, or data contained with it, inherently includes pointers that enable the rendering engine 1020 to locate the record in a contact database. In another embodiment, the pointer is obtained from another source, using the contact record identifier. For example, the pointer may be obtained from an index 146 (FIG. 1).

Step 1070 provides that the contact information that is retrieved is filleted for the particular messaging application in use. In one embodiment, the filter applied to the record information is the same for all messaging applications. In another embodiment, a more concerted effort is made to enable the filter rules 1025 to extract all field values other than those that are legitimate recipient addresses for the particular messaging application 1010 in use.

Step 1080 provides that filtered contact information is displayed to the user. A window or other display functionality can be used to display the contact record information. For example, a flared window may be used to display the contact record information at one time. Alternatively, an in-line view may be provided right on the address field, which intermittingly displays one recipient address, then another from the contact record. The user can then select one of the recipient addresses, and use navigation or scrolling to view on the address line.

According to one or more embodiments, address field viewing may be used to cause editing of the address field value of a given message. Accordingly, a step 1090 may be provided to enable edit and select from displayed contact information. Thus, for example, the user may specify a contact name, which automatically causes insertion of a first email address for that contact (e.g. the contact's work email). The user can then select to view contact information for that person, and use the information to select another email address for that contact (e.g. the person's home email address).

Address Editing

One or more embodiments described herein provide for a user to have the ability to perform edit operations on an address that is established in the address field of a message. In one embodiment, the edits may be performed in-line, meaning that the address field value can be altered in the address line of a message, even after the address that is subjected to editing was established (and thus treated atomically by the messaging application). The result of the editing is a new recipient address, and possibly a new display component for the address field as a whole.

FIG. 11A illustrates components for enabling the editing and altering of contact record information from an addressed field of a messaging application, under one or more embodiments of the invention. In FIG. 11A, a system includes a messaging application 1110, an address editor 1120, and a contact database 1130. The address editor 1120 may correspond to one the resources in a library that is shared amongst different messaging applications. As such, under one implementation, a system such as described with FIG. 11A may be implemented through the system 100, as described with FIG. 1, with the address editor 1120 having correspondence to the address editor 164.

The messaging application 1110 may display an established address field value, which means an address field value is displayed and its recipient address is recognized atomically by the messaging application. From this state, a user-input may be detected to edit the address field value. In one embodiment, the user-input may be entered through use of navigational and selection input, such as through use of a multi-directional member or mechanism having a selection button. In one embodiment, the input is made through the user viewing contact record information from the rendering engine 1020 (see FIG. 10A). In another embodiment, the input is made in-line, with no separate viewing of the contact record information. In either case, the address editor 1120 receives an edit input 1116. In response, the address editor 1120 can direct or cause removal of the atomic status of the address field value that is being held by the messaging application. The address field value can then be placed in edit mode, so that the user can alter or edit it. In one embodiment, the operations performed include (i) transparent deletion or disassociation of the address field value by the. messaging application 1110 from the message, (ii) simultaneous holding in editable form of the address field value by the address editor (or by the messaging application) for purpose of receiving edits and alterations, and (iii) insertion of the recipient address of the edited address field value as a new address field value for the messaging application. By altering the address field value, the user can delete or change existing characters (both letters and numbers), as well as adding new characters to the recipient address of the address field value.

In the case where the address field value includes a contact name, contact record information 1124 can be retrieved by or for the address editor. As described with FIG. 10A, the contact name may include inherent pointers that enable retrieval of the record information 1124, although other components and resources may be used in the alternative (e.g. an index). The address editor 1120 retrieves only an instance of the contact record that corresponds to the contact name. When edit mode is selected, the address editor 1120 holds the record information 1124 for substitution into the address field of the message being addressed. The user can either (i) edit the existing address, as described in the preceding paragraph, (ii) substitute a new recipient address from the contact record of the same contact name provided for in the address field, or (iii) edit an alternative address field from the contact record information 1124, and substitute the recipient message identifier of that edit operation into the address field. In the latter case, one embodiment provides that the address editor 1120 operates with an instance of the contact record from which the information 1124 was retrieved. As such, alteration to that contact information is not stored in the contact database. Furthermore, in the latter case, if the resulting new recipient address that is substituted into the address field does not match one of the address fields of the contact record identified by the address field value before the edit operation, an embodiment provides that the contact name is dropped from the address field value. The result is that the new recipient address is displayed.

As an alternative or addition, a reverse lookup may be performed to determine and identify a new contact record name from the contact database 1130, in which the case the newly edited address field value may carry the new contact name. With reference to an embodiment of FIG. 1, matching of the recipient address to one of the contact records may be performed by the shared library 140, using functionality such as the lookup component 166 and/or the index 146.

FIG. 11B illustrates a method for enabling the editing and altering of contact record information from an addressed field of a messaging application, under one or more embodiments of the invention. A method such as described with FIG. 11B may be used in connection with, for example, a system such as described by the system of FIG. 11A. Accordingly, reference to elements of FIG. 11A, or any other figure, is intended to show only suitable elements, components or functionality for performing a given step, sub-step or operation.

In step 1150, input is received from which a recipient address may be identified. A determination is then made in step 1152 as to whether the recipient address is a contact name. If the recipient address is a contact name, step 1155 provides that the contact name is displayed as the address field value, in association with the recipient address. Else, step 1158 provides that the contact record is displayed.

In step 1160, the recipient address is established, meaning the messaging application 1110 will treat it as an atomic data item. Step 1164 provides that edit mode selection is detected for the address field value. In response, step 1168 provides that the atomic status of the address field value is removed. In one embodiment, this may correspond to, for example, the address field value being transparently disassociated from a message that is being addressed, and then re-presented by functionality corresponding to the address editor 1120.

Next, step 1170 provides that editing of the recipient address is enabled. According to one implementation, editing of the entire address field value, including the contact name (when applicable) is enabled. Different editing processes may be performed, depending on an implementation of an embodiment described. Sub-step 1172 provides one editing operation that may be enabled, in which an in-line edit can be performed. With an in-line edit, the recipient address is edited in the line of the address field. This may involve adding characters, deleting characters, and otherwise modifying the address field value.

In the case where the address field value under edit includes a contact name, one implementation provides in a sub-step 1174 that an alternative recipient address from the contact record of the same contact name is displayed. Following sub-step 1174, there may be one of two possibilities: (i) step 1178 provides that the user can select an alternative recipient address from the contact record of the contact name in the address field value under edit, and/or (ii) step 1180 provides that the user is enabled to select, then edit an alternative recipient addresses from the contact record of the contact name in the address field value under edit. In the latter case, the edit may be in the form of addition and/or deletion of characters that comprise the recipient address.

Following either sub-step 1172 or sub-step 1180, a determination is made in step 1184 as to whether the newly specified edited address is in the contact database. If the determination is negative, step 1194 provides that the edited recipient address is displayed and established atomically for the messaging application. Otherwise, if the determination is positive, then step 1190 provides that the contact name containing the newly specified recipient address is displayed as the address field value, and the newly specified recipient address is established atomically by the messaging application.

Following step 1178, where the user has selected a new recipient address from the contact record of the contact name in the address field under edit, a step 1198 provides that the same contact name is displayed in the address field view after the edit operation is complete. However, the newly selected recipient address is established in place of the previous recipient address.

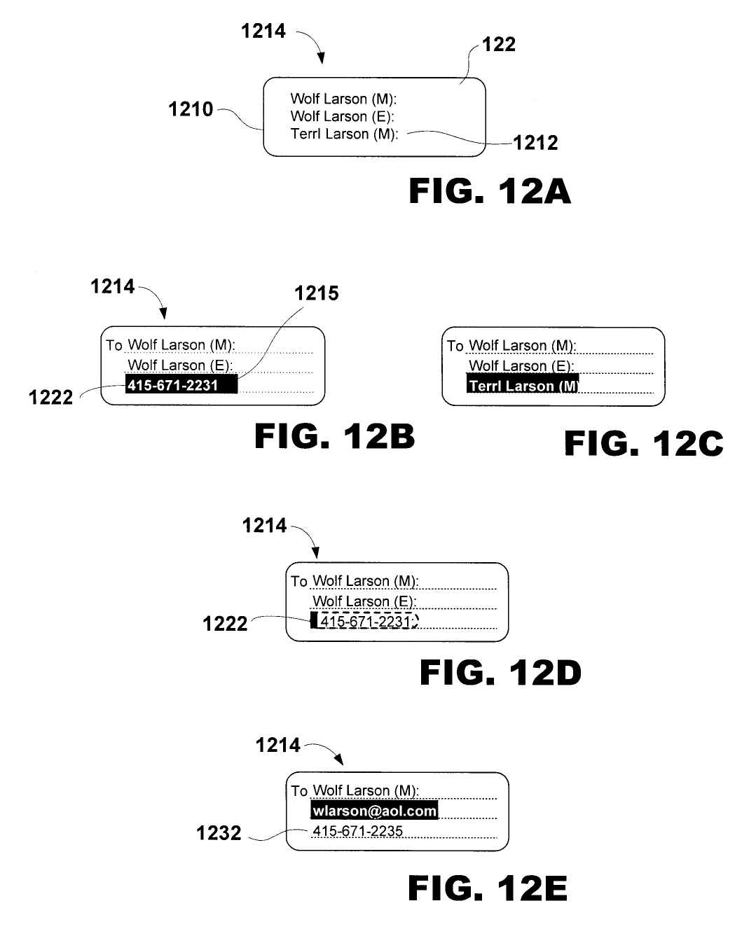

FIG. 12A-12E are illustrations of a user-interface or address window presented with a given messaging application, describing a sequence of events by which the user can select and edit and address field value, under one or more embodiments of the invention.

In FIG. 12A, an address field window 1210 of a messaging application is shown. The address field window 1210 may include multiple address lines 1212 in the address field 1214. FIG. 12B and FIG. 12C illustrate alternative results of a view or edit selection input made on one of the address field values 1215. The view or edit selection input may correspond to the user placing one of the address field values 1215 in focus. In FIG. 12B, the result of the view or edit selection is that the recipient address 1222 of the selected address field value 1215 is displayed. In FIG. 12C, recipient address is displayed when the selected address field value is placed in focus.

With regard to FIG. 12B and FIG. 12C, one embodiment (now completely shown in FIG. 12A-12E) is that placing the address field value 1215 in focus results in display of record information from the contact record of the contact name for the selected item (“Terri Larson”). FIG. 12B illustrates the display of the recipient address used from that contact record, but other embodiments and implementations may utilize a window or other mechanism to display more information from the same contact record. With reference to FIG. 12B, for example, alternative recipient addresses from that same contact record may be displayed on the address line of the selected address field value.

One or more embodiments enable editing of the address field value after the view or edit input is received. FIG. 12D shows that the selected address field view 1215 is made to display the underling recipient address 1222. This may be done with various types of user-interaction, such as through additional selection from view input, or simply through placing the selected address field value in a focused or partially selected state.

In FIG. 12E, a newly specified recipient address 1232 is shown, in place of the previous recipient address 1222 under edit. The newly specified recipient address 1232 is formed by a simple substitution of one character in the recipient address 1222. FIG. 12E shows the case where the newly specified recipient address 1232 is not associated with a contact record in the contact database. However, in one or more embodiments, a reverse lookup can be performed on the newly specified address, and if the lookup results in identification of a contact record, then the address line would display the contact name of that identified record.

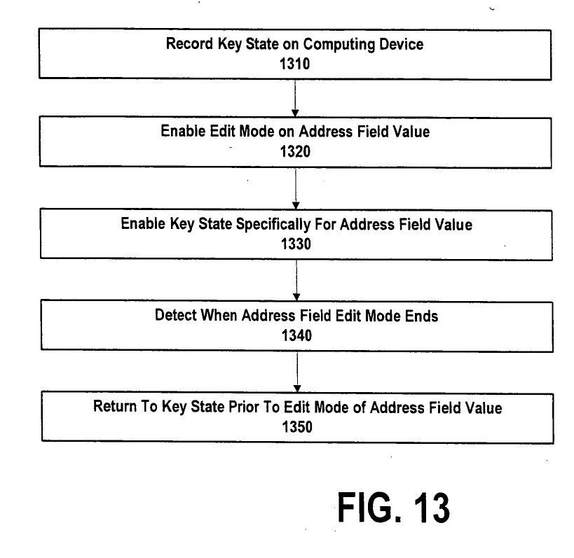

FIG. 13 illustrates a method where editing operations of an address field can be incorporated into the operational state of a device, under an embodiment of the invention. In many cases, small computing devices carry keyboards and keypads that, due to the limited real-estate, require use of key states. For example, some mobile computing devices require a number mode selection to interpret key strikes from select keys on the keyboard as numbers. A method such as illustrated by FIG. 13 facilitates the switching between editing address fields and enabling keypad operations by ensuring the key state of the device is returned to what it was before address editing was initiated.

In step 1310, the key state of a keypad or keyboard on the computing device is recorded. The following are examples of possible key states: (i) number mode, (ii) letter mode, and (iii) special character mode.

As described with, for example, a method of FIG. 11B, edit mode is enabled and selected by the user in step 1320. In step 1330, the key state for use with the edit mode of the address field is selected. In one embodiment, this made be done automatically, or programmatically. For example, in the case where the messaging application is an SMS message, a default key state may be used in which case key strikes that have alternating number/letter values are presumed to be numbers. The receipt of a non-numeric input (e.g. key strike that has no number value) may switch out of the state, or the user may select out of the state. In another implementation, however, the key state for use with the edit mode of the address field is manually selected.

In step 1340, the edit mode of the address field is detected as ending. This may correspond to, for example, establishment of the address field value after its edit mode is triggered (meaning the likelihood that the user has done something to specify the alteration).

In step 1350, the key state of the keypad or keyboard is returned to the key state recorded in step 1310, upon completion of the edit mode. This step may be performed automatically. Thus, for example, if the user edited a phone number in the address field, the key state may return to recognizing those same keys as letters.

Hardware Description

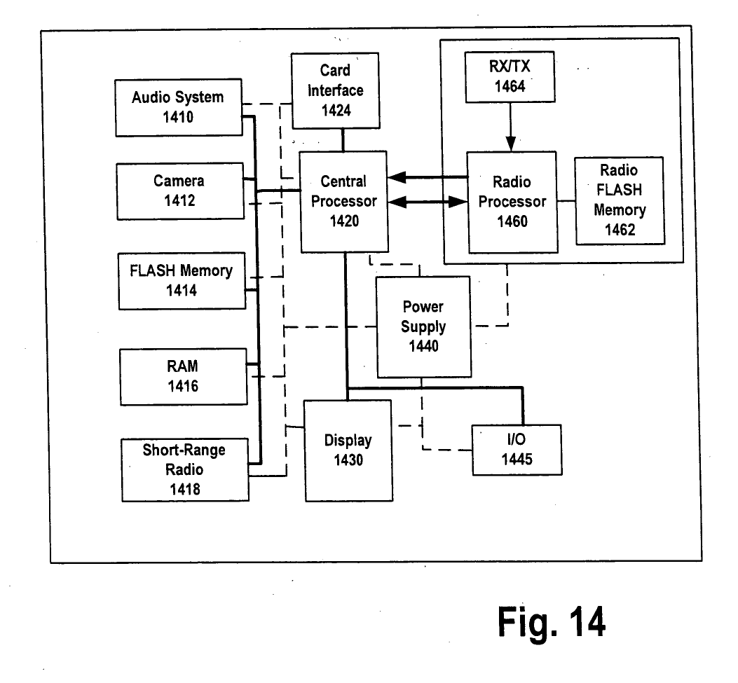

While numerous types of computing devices and systems are contemplated for the different embodiments described herein, one or more embodiments contemplate the use of a mobile computing device that transmits and receives messages through various mediums, including through cellular networks. FIG. 14 illustrates a hardware diagram of a mobile computing device configured according to an embodiment of the invention.

A mobile computing device 1400 such as shown by FIG. 14 may correspond to a device that is multi-functional, having as at least one primary function, cellular telephonic capabilities. Accordingly, the computing device 1400 includes a central processor 1420, a power module 1440, and a radio subsystem 1450. The central processor 1420 communicates with: audio system 1410, camera 1412, Flash memory 1414, RAM memory 1416 (where for example, the index 146 may be maintained), and short range radio module 1418 (e.g. Bluetooth and/or Wireless Fidelity component). The power module 1440 powers the central processor 1420 and the radio subsystem 1450. Other components that communicate with the processor 420 and which are powered by power module 440 include a display 1430 (which may be contact-sensitive) and one or more input/output mechanisms (e.g. buttons, keyboards etc.). The power module 1440 may correspond to a battery pack (e.g. rechargeable) or a powerline connection or component. Numerous other components and variations are possible to the hardware architecture of the computing device 1400, thus an embodiment such as shown by FIG. 14 is just illustrative of one implementation for an embodiment of the invention.

The radio subsystem 1450 may include a radio processor 1460, a radio memory 1462, and a receiver/transmitter 1464. While other components may be provided with the radio subsystem 1450, the basic components shown provide the ability for the mobile computing device to perform radio-frequency communications, including telephonic communications. In an embodiment, many, if not all, of the components under the control of the central processor 1420 are not required by the radio subsystem 1450 when a call is connected or ongoing.

The radio processor 1460 may communicate with central processor 1420 using a serial line 1478. In one embodiment, central processor 1420 executes logic (by way of programming, code, instructions) corresponding to the shared library 140 of FIG. 1, and components described with the library 140. The memory components 1414, 1416 may be used to store programs and instructions for carrying out any of the embodiments described herein. The central processor 1420 may access and execute these instructions to perform or implement one or more embodiments described herein. The memory components 1414, 1416 may also store or hold contact records and/or the contact database referred to by one or more embodiments described herein. The display 1430 may display to the user the various interfaces from which embodiments described herein are provided (e.g. message address editing). The radio subsystem 1450 may be used to transmit and receive messages through the various transports and applications described herein.

### Other Embodiments

With regard to the display of a list, window or other view, one or more embodiments contemplate use of a small-form factor computing device (e.g. mobile device) on which display area is limited. In such embodiments, a determination may be made as to where the list or view is to be presented, so that more of the list or view may be displayed without requiring the user to scroll up or down. In one embodiment, the screen area below and above the point from which a window, list or other view is to be generated is calculated. The portion of the display area having the most available space is used to present the list, window or other view. Such an embodiment may be applied, to for example, presentation of an MRU list as described above.

With regard to embodiments described herein, visual or other feedback may be provided to the user to inform the user about success or failure of operations that user performs. For example, whenever a new recipient address or address field value is specified, color coding may be used to inform the user as to whether the recipient address/address field value is established (and this atomic), or whether there is a problem with the entry (e.g. text was used in a field requiring only phone number, or phone number was too short to be legitimate). An error may be displayed in an alternative color, indicating non-established and erroneous status. For example, a blue address field may signify an established address field value, while red denotes non-established, and erroneous address field value.

While embodiments described herein are provided in the context of computers, and more particularly mobile computing devices, one or more other embodiments may be implemented on web-based messaging systems. Web-based messaging systems may be executed through a browser, or other application that can render images and data provided on a website. As such, the messaging applications may be substituted for a browser, or a multi-purpose application that has browsing capabilities. With regard to an embodiment such as described with FIG. 1, for example, a messaging application may be part of a larger suite of web-based products that include a contact database and messaging applications that can extend across protocols (e.g. email to SMS). Such applications may be accessed by different kinds of mobile computing devices. Features and functionality such as described with any of the embodiments described herein may be integrated or incorporated with such web-based messaging applications or suites, particularly when the computer accessing such web based products is a mobile computing device.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

What is claimed is:

1. A method for enabling a user to operate a plurality of messaging applications on a computing device, the method comprising:
identifying information about a recipient of a message that is composed or transmitted from the computing device using any of the plurality of applications;
generating a list entry from the information;
updating a list of most recently used recipients for the one or more messaging applications using the list entry; and
displaying the list in response to a user action.

2. The method of claim 1, wherein displaying the list in response to a user action includes displaying the list in response to the user action while operating one of the plurality of messaging applications.

3. The method of claim 1, further comprising associating at least a subset of list entries that comprise the list with a particular one of the messaging applications.

4. The method of claim 1, further comprising associating at least a first subset of list entries that comprise the list with a first messaging application from which the information about the recipient of each of the list entries in the first subset was identified, and associating at least a second subset of list entries that comprise the list with a second messaging application from which the information about the recipient of each of the list entries in the second subset was identified.

5. The method of claim 1, wherein identifying information about a recipient of a message includes identifying a name of a contact record that contains a recipient address uses to transmit the message.

6. The method of claim 5, wherein generating a list entry from the information displaying the name of the contact record as at least a part of the list entry.

7. The method of claim 6, wherein displaying the name of the contact record as at least a part of the list entry includes displaying, along with the identifier of the contact record, an indicator of a particular messaging identifier contained in the identified contact record.

8. The method of claim 1, wherein updating a list of most recently used recipients includes maintaining the list at a designated number.

9. The method of claim 1, wherein displaying the list in response to a user action includes displaying the list to assist the user in addressing a message using one of the one or more messaging applications.

10. The method of claim 9, wherein displaying the list to assist the user in addressing a message includes making a determination as to where to place the list in relation to an address field of the message.

11. A method for enabling a user to operate one or more messaging applications on a computing device, the method comprising:
identifying information about a recipient of a message that is composed or transmitted from the computing device using the one or more messaging applications;
forming a list entry, wherein forming the list entry includes:
if an address field value of the message is associated with a contact record on the computing device, using the identifier of the contact record to form at least a portion of the list entry,
else using a recipient address of the address field value to form the list entry; and
updating a list of most recently used recipients for the one or more messaging applications using the list entry.

12. The method of claim 11, further comprising displaying the list in response to a user action.

13. A computing device comprising:
a contact database;
a plurality of messaging applications; and
an index having index data generated from the contact database, wherein the index data can be used to perform an operation requiring identification of a record from the contact database;
and wherein each of the plurality of applications are operable to use the index.

14. The computing device of claim 13, further comprising a lookup component that is operable in connection with execution of any of the plurality of messaging applications, wherein the lookup component is configured to retrieve one or more records from the index that match a search string.

15. The computing device of claim 14, further comprising a rendering engine that is operable with the lookup component to enable display of information from the one or more records from the index.

16. The computing device of claim 15, wherein the rendering engine displays information that excludes at least some information from the one or more records, wherein the excluded information is not relevant to the one or more messaging applications.

17. The computing device of claim 13, wherein the index is persistently maintained to survive a soft-reset.

18. The computing device of claim 15, further comprising a set of filter rules that filter each contact information retrieved by the lookup component for information that is determined to be most pertinent to the message application from the plurality of message application that uses the lookup component.

19. The computing device of claim 13, further comprising a list manager that maintains at least a first list of most-recently used recipient addresses, and wherein the lookup component is configured to retrieve one or more records that match a search string from both the index and the first list.

20. The computing device of claim 19, wherein the list manager maintains a list for each of the plurality of messaging applications.
